(19) United States
(12) Patent Application Publication
(10) Pub. No.: US 2006/0172603 A1
(43) Pub. Date: Aug. 3, 2006

(54) Memory card connector with means for preventing erroneous card insertion

(76) Inventors: Yasuyoshi Matsumoto, KANAGAWA (JP); Mitsuhiro Tomita, Kanagawa (JP)

Correspondence Address: Stacey E Caldwell;Molex Incorporated, 2222 Wellington Court, Lisle, IL, 60532, US

(21) Appl. No.: 10/529,658

(22) PCT Filed: Sep. 26, 2003
(86) PCT No.: PCT/US03/30528

§ 371 Date: Jan. 9, 2006

(30) Foreign Application Priority Data
Oct. 3, 2002 (JP) 290654/2002

(51) Int. Cl. H01R 24/00

(52) U.S. Cl. 439/630

(57) ABSTRACT

A memory card connector (14) includes an insulating housing (16) defining a front receptacle area communicating with an interior cavity (22) for receiving a memory card. A plurality of terminals (20) are mounted on the housing in a side-by-side array transversely across a rear of the housing. The terminals (20) have contact portions (20b) at a rear of the cavity for engaging contacts on a top side of the memory card. A sheet metal shell (18) covers at least a portion of the insulating housing (16) and includes a cover plate overlying at least a portion of the cavity. The shell (18) has a wrong a insertion-proof projection (78) formed out of the cover plate and extending downwardly into the cavity and into a slot in the top of the memory card when the card is properly inserted into the cavity. The projection prevents an erroneously inserted memory card from engaging the contact portions of the terminals. The projection (78) is bent into an elbow-shaped cross-sectional configuration to prevent scarring or cracking of the memory card when erroneously inserted into the cavity.

### FIELD OF THE INVENTION

This invention generally relates to the art of electrical connectors and, particularly, to a memory card connector. The invention is specifically directed to a system for protecting the terminals of the card connector in the event of erroneous or abnormal insertion of the memory card into the connector.

### BACKGROUND OF THE INVENTION

Memory cards are known in the art and contain intelligence in the form of a memory circuit or other electronic program. Some form of card reader reads the information or memory stored on the cad. Such cards are used in many applications in today's electronic society, including video cameras, digital still cameras, smartphones, music players, ATMs, cable television decoders, toys, games, PC adapters, multi-media cards and other electronic applications. Typically, a memory card includes a contact or terminal array for connection through a card connector to a card reader system and then to external equipment. The connector readily accommodates insertion and removal of the card to provide quick access to the information and program on the card. The card connector includes terminals for yieldingly engaging the contact array of the memory card. Ejecting devices often are provided for facilitating inserting and ejecting the memory card to and from the card connector.

In such card connectors, it is possible to insert the memory card into the card-receiving cavity in an erroneous orientation, such as a reversed front-to-back orientation or an upside-down orientation. Such erroneous insertions could cause damage or deformation to the contact portions of the terminals if not corrected. In order to prevent the wrong insertion of a card, one type of card connector has a rib projecting from the bottom of the insulating housing. The rib projects into the card-receiving cavity so that the card abuts the rib before engaging the contact portions of the terminals if the card is inserted upside-down or in a front-to-back orientation. For example, see Japan Patent Laid-Open No. 2001-160458.

Another example of a card connector having an erroneous card insertion prevention means is shown in Japan Patent Laid-Open No. 2002-83651. As shown in that patent, a stopper projection extends inwardly from one longitudinal side of the cavity, preventing the card from engaging the contact portions of the terminal if the card is inserted in an upside-down orientation or a reversed front-to-back orientation. Unfortunately, this arrangement increases the overall size of the card connector.

In order to avoid increasing the size of the card connector, another example of a wrong insertion-proof card connector is shown in FIG. 13 herein. As shown, an overlying metal shell “a” is stamped and formed with a depending projection “b” which extends into the card-receiving cavity “c”. With a properly inserted card, the projection extends into a slot in the top of the card. If the card is wrongly oriented relative to the connector, the card abuts depending projection “b” to prevent the card from engaging the contact portions of the terminal. Unfortunately, depending projection “b” is so thin (see cross-hatched thickness “bb”, approximately 0.2 mm thick) that the projection scars or cracks the fragile plastic casing of the card when the card is repeatedly pushed against the thin or sharp projection.

The present invention is directed to solving the various problems outlined above and providing improvements over the described prior art.

### SUMMARY OF THE INVENTION

An object, therefore, of the invention is to provide a new and improved memory card connector with erroneous card insertion prevention.

In the exemplary embodiment of the invention, a memory card connector includes an insulating housing defining a front receptacle area communicating with an interior cavity for receiving a memory card. A plurality of terminals are mounted on the housing in a side-by-side array transversely across a rear of the housing. The terminals have contact portions at the rear of the cavity for engaging contacts on a top side of the memory card. A sheet metal shell covers at least a portion of the insulating housing and includes a cover plate overlying at least a portion of the cavity. The shell has a wrong insertion-proof projection formed out of the cover plate and extending downwardly into the cavity and into a slot in the top of the memory card when the card is properly inserted into the cavity. The projection prevents an erroneously inserted memory card from engaging the contact portions of the terminals. The projection is bent into a rounded elbow-shaped cross-sectional configuration to prevent scarring or cracking of the memory card when erroneously inserted into the cavity.

According to one aspect of the invention, the wrong insertion-proof projection is bent into a generally U-shaped configuration. The projection may be bent into a generally L-shaped configuration or a J-shaped configuration or a V-shaped configuration, all having a rounded elbow for engaging the memory card.

As disclosed herein, the sheet metal shell includes a pair of depending opposite side walls integral with and depending from opposite longitudinal edges of the cover plate. The side walls include mounting tabs bent outwardly at bottom edges of the walls for mounting the connector on a circuit board.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1(a) is a front elevational view of a memory card connector embodying the concepts of the invention, and FIG. 1(b) is an enlarged view of the encircled portion “A” of FIG. 1(a);

FIG. 2 is a top plan view of the card connector;

FIG. 3 is a rear elevational view of the card connector;

FIG. 4 is a side elevational view of the card connector, looking at the right-hand side of FIG. 2;

FIG. 5 is a side elevational view of the card connector, looking at the left-hand side of FIG.2;

FIG. 6 is an enlarged vertical section through the area of the connector where the terminals are mounted in the housing;

FIG. 7 is an enlarged perspective view of the area of the connector where the wrong insertion-proof projection extends downwardly from the cover plate of the metal shell;

FIG. 8 is a perspective view of the memory card connector, with the metal shell removed;

FIG. 9 is a view similar to that of FIG. 1(b) but of an alternative embodiment of the invention;

FIG. 10 is an enlarged, fragmented elevational view of the area of the connector where the mounting tab is formed in one of the side walls of the metal shell;

FIGS. 11 and 12 are views similar to that of FIGS. 1(b) and 9, showing further alternative embodiments of the invention; and

FIG. 13 is a view of the prior art described in the “Background”, above.

### DETAILED DESCRIPTION OF THE PREFERRED EMBODIMENT

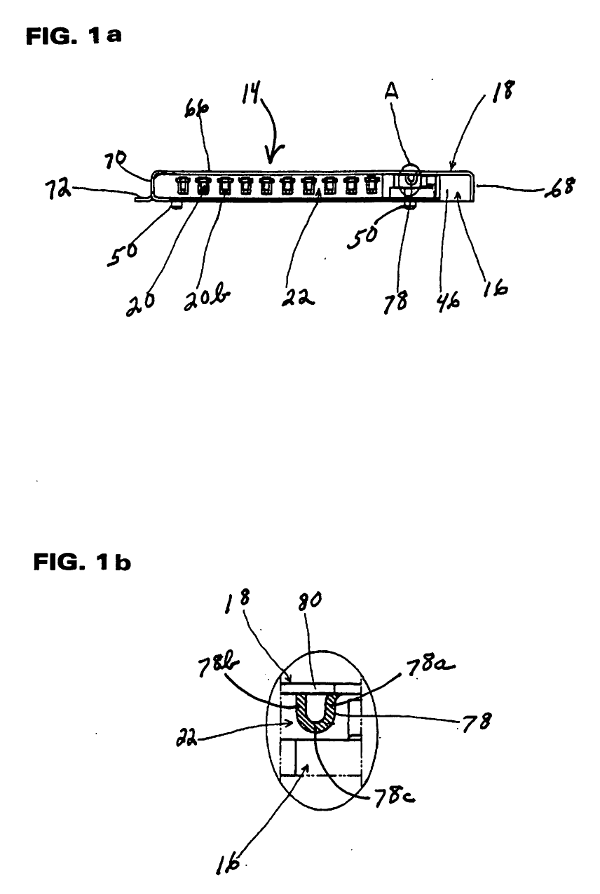

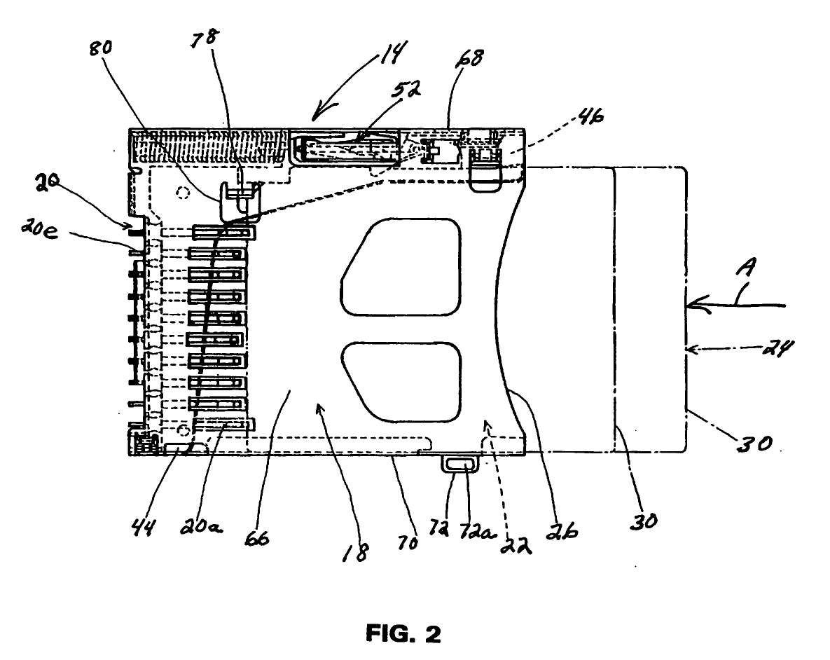

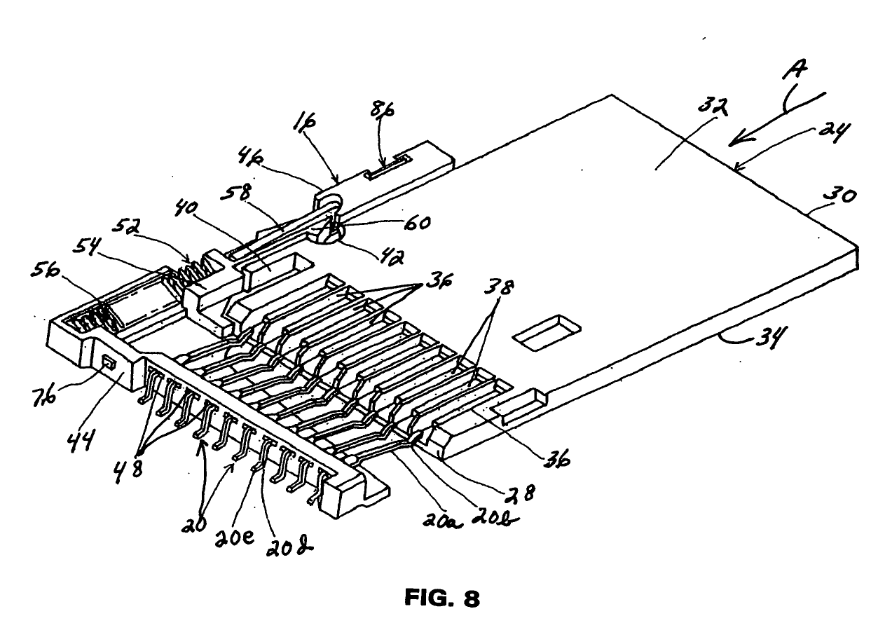

Referring to the drawings in greater detail, and first to FIGS. 1(a) -5 and 8, the invention is embodied in a memory card connector, generally designated 14, which includes an insulating housing, generally designated 16, and a stamped and formed sheet metal shell, generally designated 18, covering the insulating housing. The housing mounts a plurality of conductive terminals, generally designated 20, mounted on the housing in a side-by-side array transversely across a rear of the housing as best seen in FIG. 8. The housing and metal shell 18 combine to define an interior cavity, generally designated 22 (FIG. 1), for receiving a memory card, generally designated 24, inserted into a front receptacle area 26 (FIG. 2) of the connector in the direction of arrow “A” (FIGS. 2 and 8).

As best seen in FIG. 8, memory card 24, when properly oriented for insertion into the connector, includes a front leading edge 28, a rear trailing edge 30, a top flat surface 32 and a bottom flat surface 34. A plurality of contact slots 36 are cut into top flat surface 32, with the slots opening at front leading edge 28 of the card. Contacts 38 are disposed at the bottom of the slots for engaging contact portions of terminals 20. A wrong insertion-proof slot 40 also is cut into top flat surface 32 of the card. Finally, a recess 42 is cut into one side edge of the card, for purposes described hereinafter.

Insulating housing 16 is shown best in FIG. 8 but also in conjunction with FIG. 2. The housing is generally L-shaped to define a terminal-mounting section 44 which extends transversely across the rear of the housing, along with a longitudinal side wall section 46 which projects forwardly of one end of the terminal mounting section. The terminals extend through openings 48 in the mounting section.

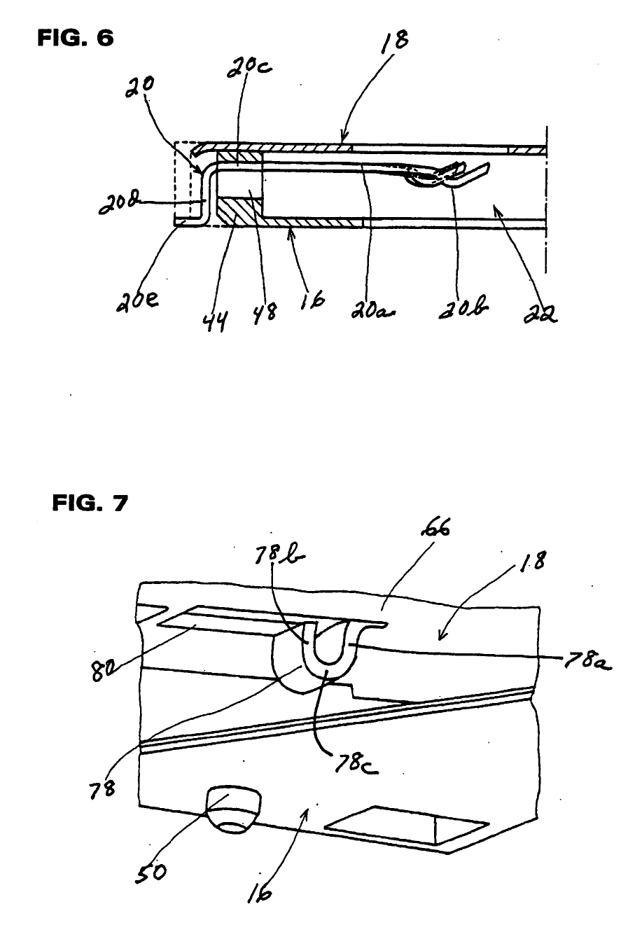

Referring to FIG. 6 in conjunction with FIG. 4, each terminal 20 includes a contact arm 20a cantilevered forwardly into the card-receiving cavity 22 and terminating in a contact portion 20b for engaging a respective one of the contacts 38 in a respective contact slot 36 in memory card 24. Contact arm 20a projects forwardly from a mounting base 20c of the terminal which is press-fit into a respective one of the openings 48 in terminal-mounting section 44 of the housing. A solder tail portion 20d of the terminal projects outwardly of the rear of the housing and terminates in a soldering pad 20e for solder-connection to a respective circuit trace on a printed circuit board (not shown). The housing has a plurality of mounting pegs 50 (FIGS. 1(a), 3-5 and 7) for insertion into appropriate mounting holes in the printed circuit board.

Longitudinal side wall section 46 of housing 16 mounts a push/pull-type card ejection mechanism, generally designated 52, and also best seen in FIG. 8. The card ejection mechanism is provided for ejecting and removing memory card 24 from the connector and is of a type known in the art. Suffice it to say, the card ejection mechanism includes a slider 54 slidable on the side wall section, a coil spring 56 for urging the slider toward the front receptacle area 26 (FIG. 2) of the connector, a pin member 58 positioned between side wall section 46 and slider 54 for cooperating with a heart-shaped cam slot (not shown) of the slider. The push/pull-type card ejection mechanism 52 is well known in the art. When memory card 24 is inserted into card receiving cavity 22, a locking arm 60 of the slider is caught by recess 42 in the side edge of the card so that the slider moves with the card in its insertion direction while compressing coil spring 56. When the card is unlatched, it is ejected from the card-receiving cavity under the force of coil spring 56. The initial and fully inserted positions of the memory card are shown by the phantom lines in FIGS. 2, 4 and 5.

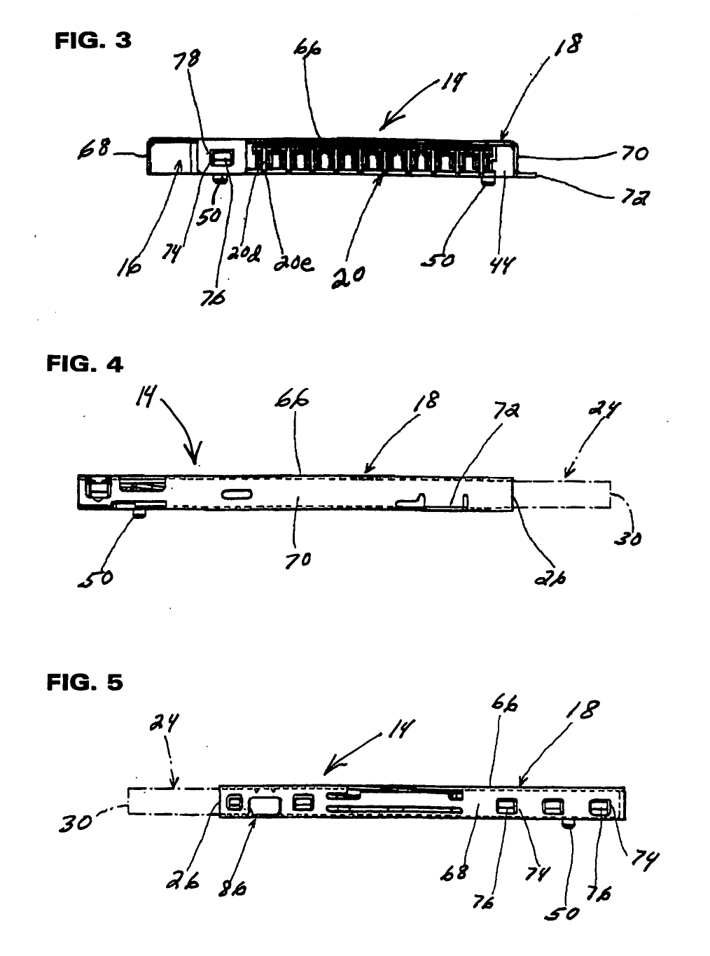

Referring to FIGS. 1-5, metal shell 18 is stamped and formed of thin sheet metal material and is large enough to cover substantially the entire area defined by insulating housing 16. The metal shell includes a top cover plate 66 and a pair of depending opposite side walls 68 and 70 which run in a front-to-rear direction of the connector. Side wall 68 covers card ejection mechanism 52. Side wall 70 defines the opposite side of card-receiving cavity 22 as best seen in FIG. 1(a). Side wall 70 includes a mounting tab 72 having a hole 72a (FIG. 2) for securement to the printed circuit board. Side wall 68 has a plurality of openings 74 for receiving a plurality of latch projections 76 on the housing so that the metal shell can be snapped into engagement with the housing. Similarly, a rear latch tab 78 (FIG. 3) depends downwardly at the rear of the connector and also has an opening 74 for snapping into engagement with a latch projection 76 on the housing. In general, it can be seen that metal shell 18 is in the general configuration of an inverted U-shaped member.

Referring to FIGS. 1, 2 and 7, the invention contemplates a wrong insertion-proof projection 78 stamped and formed out of a hole 80 (FIG. 7) in top cover plate 66 of sheet metal shell 18. The projection is bent into a rounded elbow-shaped cross-sectional configuration. In other words, FIG. 7 clearly shows that projection 78 is bent downwardly, as at 78a, from top cover plate 66 and is bent back upwardly, as at 78b, to form a rounded elbow 78c. Referring back to FIG. 8, when memory card 24 is inserted into the connector in its proper orientation, projection 78 will easily move into slot 40 in top flat surface 32 of the memory card. However, if the card is inserted into the connector in an upside-down orientation, front leading edge 28 of the card will abut projection 78 and prevent that edge from engaging contact portions 20b of terminals 20. Similarly, if the memory card is inserted into the connector in a reverse front-to-back orientation, rear edge 30 of the memory card will abut projection 78 and, again, the edge of the card will be prevented from engaging contact portions 20b of terminals 20. By forming projection 78 into a rounded elbow-shaped cross-sectional configuration, scarring or cracking of the memory card is prevented when the card is erroneously inserted into the connector. The configuration of the projection in FIGS. 1, 2 and 7 is that of a U-shaped configuration.

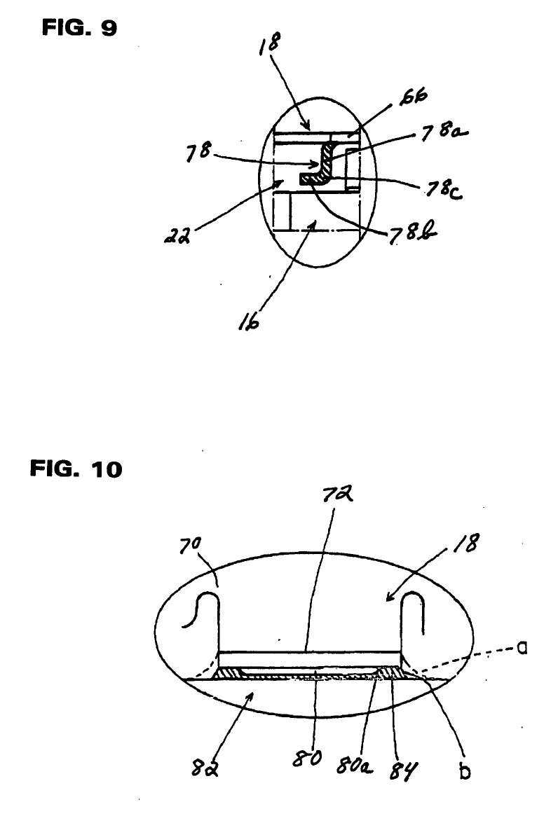

FIG. 9 shows a alternative embodiment of the wrong insertion-proof projection 78 wherein the projection is bent into a generally L-shaped configuration in cross-section. Specifically, the projection is bent downwardly from top cover plate 66 to form a vertical leg 78a and a horizontal leg 78b, to define a rounded elbow 78c therebetween.

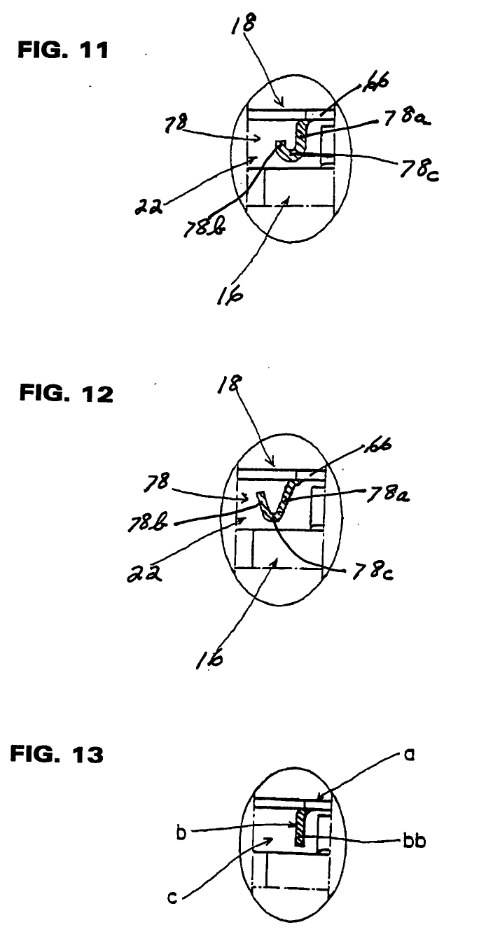

FIG. 11 shows another alternative embodiment wherein wrong insertion-proof projection 78 is bent downwardly from top cover plate to form a vertical leg 78a and an up-turned leg 78b to form a rounded elbow 78c therebetween. In essence, projection 78 in FIG. 11 is bent into a generally J-shaped configuration.

FIG. 12 shows a further alternative embodiment of the invention wherein wrong insertion-proof projection 78 is bent downwardly from top cover plate 66 to form an angled leg 78a and an up-turned angled leg 70b to form a rounded elbow 78c therebetween. In essence, projection 78 in FIG. 12 is bent into a generally V-shaped configuration.

All of the various configurations of the U-shaped projection in FIGS. 1 and 7, the L-shaped configuration in FIG. 9, the J-shaped configuration in FIG. 11 and the V-shaped configuration in FIG. 12 present a rounded elbow for engaging the memory card if the card is inserted into the connector in an erroneous orientation. This prevents scarring or cracking of the memory card.

Lastly, FIG. 10 shows mounting tab 72 which projects outwardly from side wall 70 of metal shell 18. The mounting tab has a horizontal section 80 formed at the bottom thereof, with the horizontal projection being located at the same level as the soldering pads 20e of terminals 20. Horizontal section 80 has a rounded edge 80a. The connector is mounted to a printed circuit board 82. It is difficult to plate horizontal section 80 completely about its circumference and, therefore, soldering is most likely to form as indicated by solid line “b” rather than broken line “a” whereby a good resistance to peeling forces may not be given. With horizontal section 80 being rounded about its circumference 80a, solder material 84 migrates to the bottom of the horizontal section as well as about the circumference of the section to provide a good soldering filet to provide anti-peeling resistance. Although only one of the mounting tabs 72 are shown on side wall 70 of the metal shell, more than one mounting tab can be provided along either side wall of the shell. Alternatively, a metal fitting nail 86 (FIGS. 5 and 8) may be embedded in longitudinal side wall section 46 of the housing and soldered to a soldering pad on the printed circuit board.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A memory card connector, comprising:
an insulating housing defining a front receptacle area communicating with an interior cavity for receiving a memory card;
a plurality of terminals mounted on the housing in a side-by-side array transversely across a rear of the housing, the terminals having contact portions at a rear of the cavity for engaging contacts on a top side of the memory card;
a sheet metal shell covering at least a portion of the insulating housing and including a cover plate overlying at least a portion of said cavity, the shell having a wrong insertion-proof projection formed out of said cover plate and extending downwardly into the cavity and into a slot in the top of the memory card when the card is properly inserted into the cavity, the projection preventing an erroneously inserted memory card from engaging the contact portions of the terminals, and the projection being bent into elbow-shaped cross-sectional configuration to prevent scarring or cracking of the memory card when erroneously inserted into the cavity.

2. The memory card connector of claim 1 wherein said wrong insertion-proof projection is bent into a generally U-shaped configuration.

3. The memory card connector of claim I wherein said wrong insertion-proof projection is bent into a generally L-shaped configuration.

4. The memory card connector of claim I wherein said wrong insertion-proof projection is bent into a generally J-shaped configuration.

5. The memory card connector of claim 1 wherein said wrong insertion-proof projection is bent into a generally V-shaped configuration.

6. The memory card connector of claim 1 wherein said sheet metal shell includes a pair of depending opposite side walls integral with opposite longitudinal edges of said cover plate.

7. The memory card connector of claim 6 wherein said side walls include mounting tabs bent outwardly at bottom edges of the walls for mounting the connector on a circuit board.
